(19) United States
(12) Patent Application Publication
(10) Pub. No.: US 2026/0218796 A1
(43) Pub. Date: Jul. 30, 2026

(54) SORBENT FLOW REGULATOR

(71) Applicant: Mosaic Materials, Inc., Alameda, CA (US)

(72) Inventors: Samuel Cheng, Katy, TX (US); Paul Cody, Houston, TX (US); Steven Craig Russell, The Woodlands, TX (US); Dustin Kraft, Houston, TX (US)

(21) Appl. No.: 19/036,688

(22) Filed: Jan. 24, 2025

(51) Int. Cl. F16K 7/10; B01D 53/06

(52) U.S. Cl. CPC F16K 7/10; B01D 53/06

(57) ABSTRACT

A desorption structure includes a desorption chamber structured to have desorption of sorbent performed therein, the desorption chamber defining a first portion, a second portion downstream of the desorption chamber, and a sorbent flow regulator disposed within the second portion configured to control flow of the sorbent through the desorption structure.

### BACKGROUND

Various manufacturing and chemical systems include the use of sorbents to remove gas(es), vapor(s), or a mixture thereof from a fluid via adsorption. For example, carbon capture systems may capture carbon dioxide via adsorption with sorbent(s). The sorbents may then be fed to a desorption system to remove the gas(es), vapor(s), or the mixture thereof from the sorbent. Improvement in the desorption system may be desirable.

### SUMMARY

An embodiment of desorption structure including a desorption chamber structured to have desorption of sorbent performed therein, the desorption chamber defining a first portion, a second portion downstream of the desorption chamber, and a sorbent flow regulator disposed within the second portion configured to control flow of the sorbent through the desorption structure.

### BRIEF DESCRIPTION OF THE DRAWINGS

The following descriptions should not be considered limiting in any way. With reference to the accompanying drawings, like elements are numbered alike:

FIG. 1 shows a schematic diagram of a desorption system according to one or more embodiments;

FIG. 2 shows a cross-sectional view of a desorption structure according to one or more embodiments;

FIG. 3 shows a cross-sectional view of a desorption structure according to one or more embodiments;

FIG. 4A shows a cross-sectional view of a sorbent flow regulator according to one or more embodiments in an open configuration;

FIG. 4B shows the sorbent flow regulator of FIG. 4A in a closed configuration;

FIG. 5A shows a cross-sectional view of a sorbent flow regulator according to one or more embodiments in an open configuration;

FIG. 5B shows the sorbent flow regulator of FIG. 5A in a closed configuration;

FIG. 6A shows a perspective view of a sorbent flow regulator mounted on a sorbent receiving structure according to one or more embodiments;

FIG. 6B shows a lower view of the sorbent flow regulator of FIG. 6A;

FIG. 6C shows a cross-sectional view of the sorbent flow regulator of FIG. 6B taken at line 6C-6C;

FIG. 6D shows a schematic diagram of a sorbent flow regulator coupled to a fluid transfer device according to one or more embodiments;

FIG. 7A shows a perspective view of a sorbent flow regulation module according to one or more embodiments;

FIG. 7B shows a cross-sectional view of the sorbent flow regulation module of FIG. 7A with the sorbent flow regulation module in an open configuration;

FIG. 7C shows an upper view of the sorbent flow regulation module of FIG. 7A;

FIG. 7D shows the sorbent flow regulation module of FIG. 7C taken at line 7D-7D in an open configuration;

FIG. 7E shows the sorbent flow regulation module of FIG. 7D in a closed configuration;

FIG. 8A shows a perspective view of a sorbent flow regulation module according to one or more embodiments;

FIG. 8B shows the sorbent flow regulation module of FIG. 7A with a portion thereof removed;

FIG. 8C shows an upper view of the sorbent flow regulation module of FIG. 8A.

### DETAILED DESCRIPTION

A detailed description of one or more embodiments of the disclosed apparatus and method are presented herein by way of exemplification and not limitation with reference to the Figures.

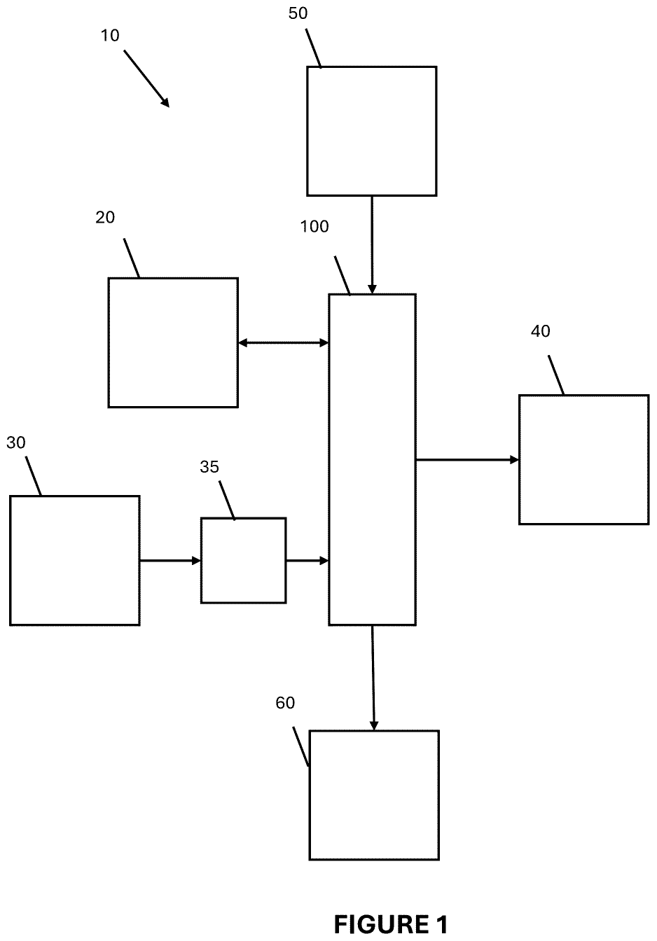

A desorption system 10 according to one or more embodiments is shown in FIG. 1. The desorption system 10 includes a desorption structure 100. The desorption structure 100 may be thermally coupled to a heat generation device 20 that provides heat energy to sorbents within the desorption structure 100. The heat generation device 20 may be any heater known in the art. As a non-limiting example, the heat generation device 20 may be a radio frequency (RF) system configured to emit electromagnetic energy. The RF system may include an RF generator and an RF waveguide extending from the RF generator to the desorption structure 100. The RF generator may be configured to generate electromagnetic energy, and the RF waveguide may be configured to propagate the electromagnetic energy by the RF generator to the desorption structure 100. The RF system may heat the sorbent within the desorption structure which may release gas(es), vapor(s), or a mixture thereof from the sorbent that previously adsorbed the gas(es), vapor(s), or the mixture thereof.

The desorption structure 100 may be fluidly coupled to a gas source 30 and a gas destination 40. A flow generator 35 may be disposed upstream of the desorption structure 100 to generator flow of gas through the desorption structure 100. The flow generator 35 may be, for example, a fan, a blower, a pump, or any other flow generation devices known in the art. The flow generator 35 may generate flow of gas from the gas source 30 through the desorption structure 100 to remove the gas(es), vapor(s), or a mixture thereof from the rich sorbent, with the gas flowing to the gas destination 40. Although the gas source 30 and the gas destination 40 are shown as separate structures, the gas source 30 and the gas destination 40 may be connected in a flow loop such that gas that flows out of the desorption structure 100 may be fed back into the desorption structure 100. The gas within the flow loop may be removed from the flow loop to remove the gas(es), vapor(s), or a mixture thereof from the flow loop. The flow generator 35 may be disposed within or be coupled to the gas loop. As non-limiting examples, desorption system 10 may perform desorption via air, carbon dioxide, and/or water steam convection.

The desorption structure 100 may be coupled to a sorbent source 50 and a sorbent destination 60. The sorbent source 50 may feed rich sorbent into the desorption structure 100, and after desorption within the desorption structure 100, the resulting lean sorbent may be removed from the desorption structure 100 to the sorbent destination 60. The rich sorbent may be gravity-fed to the desorption structure 100 from the sorbent source 50, and the lean sorbent may be gravity-fed to the sorbent destination 60 from the desorption structure 100. According to one or more embodiments, sorbent is solid sorbent (e.g. metal-organic framework materials, zeolites, mesoporous silicas, amine-functionalized solid sorbents, etc.), and may be pellets of sorbent.

As used herein, the term rich sorbent denotes a sorbent that has adsorbed gas(es), vapor(s), or a mixture thereof, and the term lean sorbent denotes that the sorbent has not yet adsorbed the gas(es), vapor(s), or the mixture thereof, or that the gas(es), vapor(s), or the mixture thereof has been removed, partially or entirely, from the sorbent via the desorption system 10. Examples of gas(es), vapor(s), or a mixture thereof adsorbed by the sorbent and removed by the desorption system 10 may include, but are not limited to, CO₂, H₂O, H₂, O₂, N₂, CO, NH₃, C₂H₄, C₂H₆, C₃H₆, C₃H, H₂S, SO₂, and NO₂.

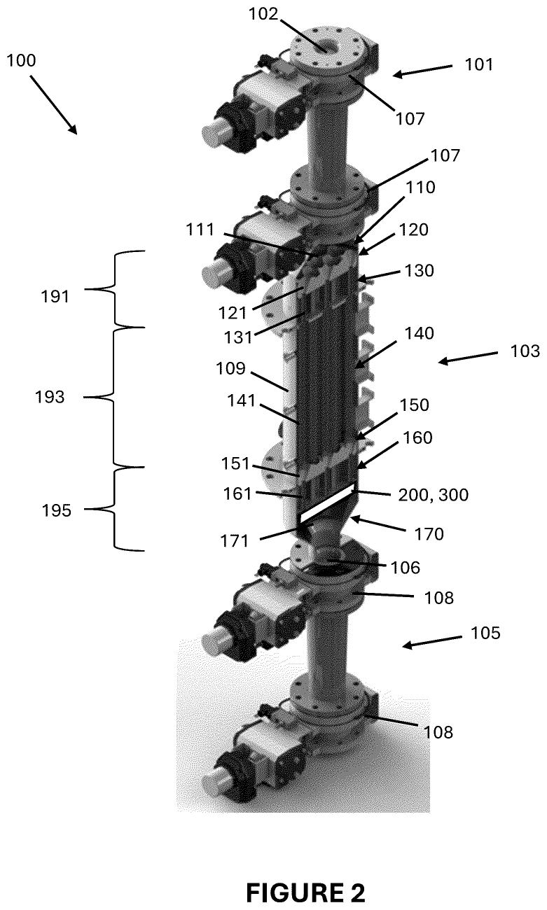

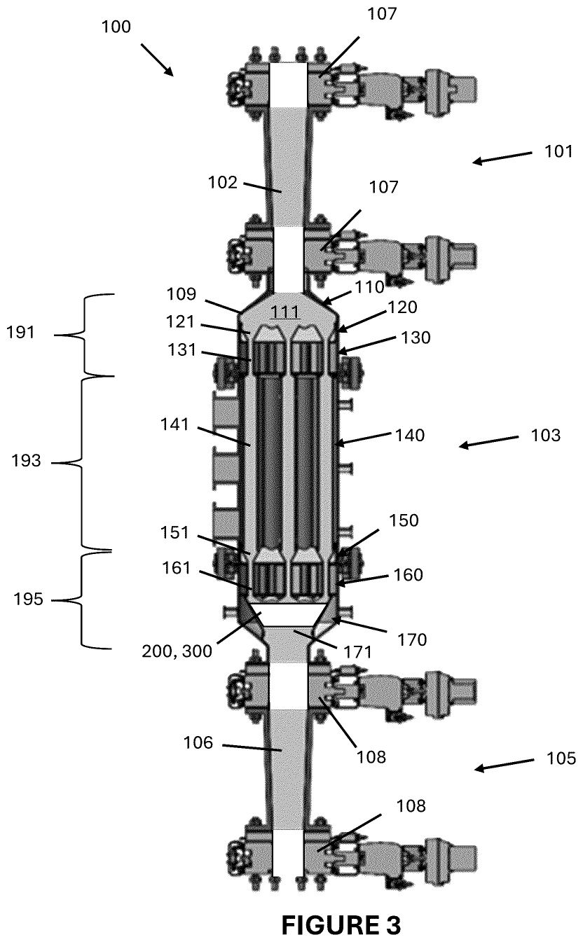

FIGS. 2 and 3 show a desorption structure 100 according to one or more embodiments. The desorption structure 100 may include an upstream portion 101, a desorption portion 103, and a downstream portion 105. The upstream portion 101 may include an upstream sorbent passage 102 through which rich sorbent from the sorbent source 50 may be fed to the desorption portion 103. The upstream portion 101 may include one or more upstream valves 107 that are configured to open to allow rich sorbent to pass therethrough to the desorption portion 103 and close to prevent the rich sorbent from passing therethrough. The downstream portion 105 may include a downstream sorbent passage 106 through which lean sorbent from the desorption portion 103 may be fed to the sorbent destination 60. The downstream portion 105 may include one or more downstream valves 108 that are configured to open to allow lean sorbent to pass therethrough from the desorption portion 103 to the sorbent destination 60 and close to prevent the rich or lean sorbent from passing therethrough.

The desorption portion 103 may include an outer casing 109. Within the outer casing 109, the desorption portion 103 may include an upstream chamber 110, an upstream funnel structure 120, a sorbent feeding structure 130, a desorption chamber 140, a downstream funnel structure 150, a sorbent receiving structure 160, and a hopper 170.

The upstream chamber 110 may define a space 111 therein which receives and collects the rich sorbent from the upstream portion 101. The upstream funnel structure 120 defines a plurality of funnel passages 121 that has a wide inlet that narrows to a narrow outlet to receive the rich sorbent collected in the space 111 of the upstream chamber 110 and funnels the rich sorbent to the sorbent feeding structure 130. The sorbent feeding structure 130 defines a plurality of sorbent passages 131 coupled to the funnel passages 121 that receives the rich sorbent from the funnel passages 121 and feed the rich sorbent to the desorption chamber 140. The sorbent feeding structure 130 may be structured to choke RF waves and isolate RF energy from propagating into the upstream chamber 110.

The desorption chamber 140 defines a plurality of desorption passages 141 coupled to the sorbent passages 131 and receive the rich sorbent from the sorbent passages 131. The desorption chamber 140 may include gas-permeable walls defining the desorption passages 141 such that, when performing desorption within the desorption chamber 140 via the heat generation device 20 and/or gas flow from the gas source 30, the gas from the gas source 30 may pass flow across and through the desorption passages 141 and gas(es), vapor(s), or a mixture thereof released from the rich sorbent may exit through the gas-permeable walls to a volume circumscribing the desorption passages 141 within the desorption chamber 140 for evacuation to the gas destination 40.

After desorption releases the gas(es), vapor(s), or a mixture thereof from the rich sorbent, the resulting lean sorbent may be fed from the desorption passages 141 to a downstream funnel structure 150. The downstream funnel structure 150 defines a plurality of funnel passages 151 that has a wide inlet that narrows to a narrow outlet to receive the lean sorbent from the desorption passages 141 and funnels the lean sorbent to the sorbent receiving structure 160. The sorbent receiving structure 160 may be structured to choke RF electromagnetic waves and isolate RF energy from propagating into the hopper 170. The sorbent receiving structure 160 defines a plurality of sorbent passages 161 coupled to the funnel passages 151 that receives the rich sorbent from the funnel passages 151 and feed the lean sorbent to the hopper 170. The hopper 170 defines a hopper chamber 171, and the desorption structure 100 includes a sorbent flow regulator 200, 300 according to one or more embodiments arranged within the hopper chamber 171. The hopper 170 is coupled to the downstream sorbent passage 106 of the downstream portion 105, and the lean sorbent passing through the sorbent flow regulator 200, 300 is fed to downstream sorbent passage 106. The lean sorbent passing through the downstream sorbent passage 106 is fed to the sorbent destination 60.

While the downstream funnel structure 150, the sorbent receiving structure 160, the hopper 170, and the sorbent flow regulator 200, 300 are described above with respect to processing and/or controlling of lean sorbent from the desorption chamber 140, the desorption system 100 is not limited thereto. For example, the downstream funnel structure 150, the sorbent receiving structure 160, the hopper 170, and the sorbent flow regulator 200, 300 may process and/or control rich sorbent as well. For example, the downstream funnel structure 150, the sorbent receiving structure 160, the hopper 170, and the sorbent flow regulator 200, 300 may process and/or control flow of rich sorbent during the filling stage of the desorption chamber 140 or during alternative operations such as system cleaning or testing.

As described above, desorption occurs at the desorption chamber 140. The upstream valves 107 and the downstream valves 108 may be closed to trap the rich sorbent within the desorption chamber 140 such that the desorption may be performed on the rich sorbent. The desorption chamber 140 may be considered a productive portion 193 of the desorption portion 103, as desorption is performed on the rich sorbent within the desorption chamber 140. A portion upstream of the desorption chamber 140, e.g., the upstream chamber 110, the upstream funnel structure 120, and/or the sorbent feeding structure 130 may be considered an upstream non-productive portion 191 of the desorption portion 103, and a portion downstream of the desorption chamber 140, e.g., the downstream funnel structure 150, the sorbent receiving structure 160, and/or the hopper 170, may be considered a downstream non-productive portion 195 of the desorption portion 103.

While flow of the lean sorbent through and out of the desorption structure 100 may be controlled by the one or more downstream valves 108, when the one or more downstream valves 108 is closed, the lean sorbent may accumulate within the hopper 170. It would be beneficial to minimize the amount of sorbent within the downstream non-productive portion 195, as the lean sorbent within the downstream non-productive portion 195 is not being desorbed or used for adsorption. Additionally, it was discovered that closing and opening of the one or more downstream valves 108 may cause shearing on the lean sorbent, causing damage thereto and attrition of the lean sorbent. One or more embodiments includes the sorbent flow regulator 200, 300 at or near an upstream end of the hopper 170 that may control flow of the lean sorbent through and out of the desorption structure 100 such that the one or more downstream valves 108 may remain open during desorption. Alternatively, the one or more downstream valves 108 may be omitted altogether. By limiting or eliminating an amount of the lean sorbent accumulating within the hopper 170, the lean sorbent may instead be used for adsorption, improving efficiency of the adsorption and desorption cycle. Additionally, by limiting or eliminating the closing and opening of the one or more downstream valves 108, damage to the lean sorbent caused thereby may be reduced or prevented.

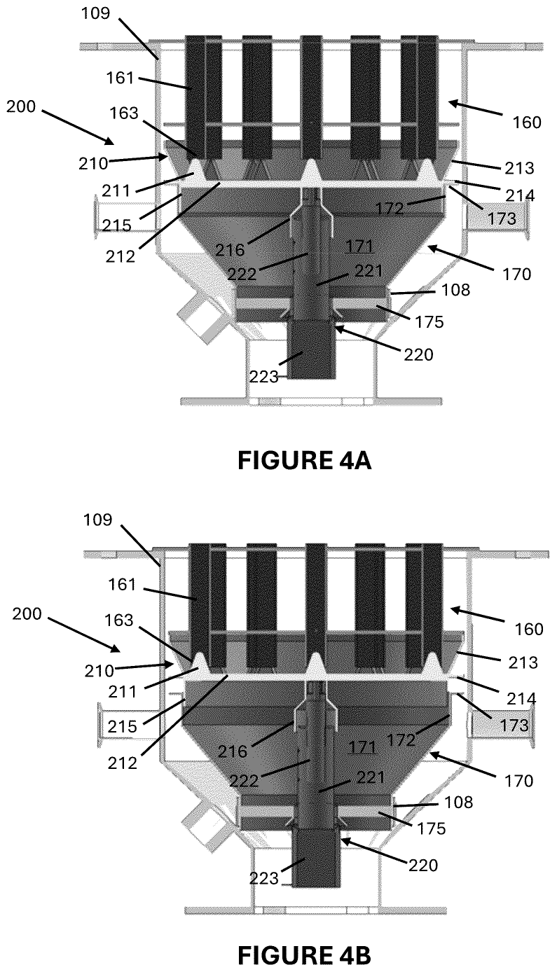

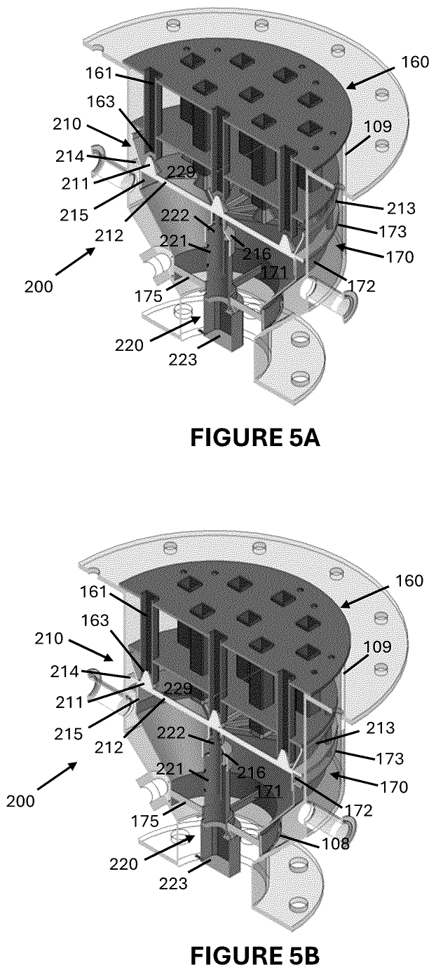

A sorbent flow regulator 200 according to one or more embodiments is shown in FIGS. 4A, 4B, 5A, and 5B. The sorbent flow regulator 200 may be positioned near or at the upstream end of the hopper 170. The sorbent flow regulator 200 may include a plug assembly 210 and an actuator assembly 220.

The plug assembly 210 may include an annular ring 214 and a plurality of spokes 212 extending between opposite sides of the annular ring 214. Openings 229 are formed between the spokes 212, and the lean sorbent may pass through the openings 229. An upstream annular wall 213 may extend from the annular ring 214 and surround the spokes 212. The upstream annular wall 213 may be sloped such that any lean sorbent that abuts the upstream annular wall 213 is directed to the openings 229. A downstream annular wall 215 may extend from the annular ring 214 on an opposite side from the upstream annular wall 213. An outer surface of the downstream annular wall 215 may abut an inner surface of an annular wall 172 of the hopper 170 to maintain alignment of the plug assembly 210 with respect to the hopper 170. A plurality of plugs 211 are formed on the spokes 212 at positions aligned with the sorbent passages 161. The plugs 211 may be a tapered shape, e.g., pyramid, frustum, cone, etc. The plugs 211 may correspond in shape to the sorbent passages 161. The plug assembly 210 may include a mounting structure 216 that is mounted on a rod structure 222 of the actuator assembly 220.

The actuator assembly 220 may include an actuator 221 and a driver 223. The driver 223 may be, for example, a motor. The actuator 221 may be mounted on the hopper chamber 171 via mounting spokes 175. The actuator 221 may be actuated by a driver 223 to move the rod structure 222 towards and away from the sorbent receiving structure 160, thereby moving the plug assembly 210 mounted thereon between an open configuration shown in FIGS. 4A and 5A and the closed configuration shown in FIGS. 4B and 5B. In the open configuration shown in FIGS. 4A and 5A, there are gaps between outlets 163 of the sorbent passages 161 and the plugs 211 such that the lean sorbent may flow out of the outlets 163 and pass through the openings 229 to an outlet of the hopper 170. In the open configuration, the annular ring 214 may be positioned on an outer flange 173 of the hopper 170. In the closed configuration shown in FIGS. 4B and 5B, the plugs 211 extend into the outlets 163 of the sorbent passages 161 such that the lean sorbent cannot pass through the sorbent flow regulator 200. Thus, by actuating the actuator assembly 220, the sorbent flow regulator 200 may regulate flow of the lean sorbent through the desorption structure 100.

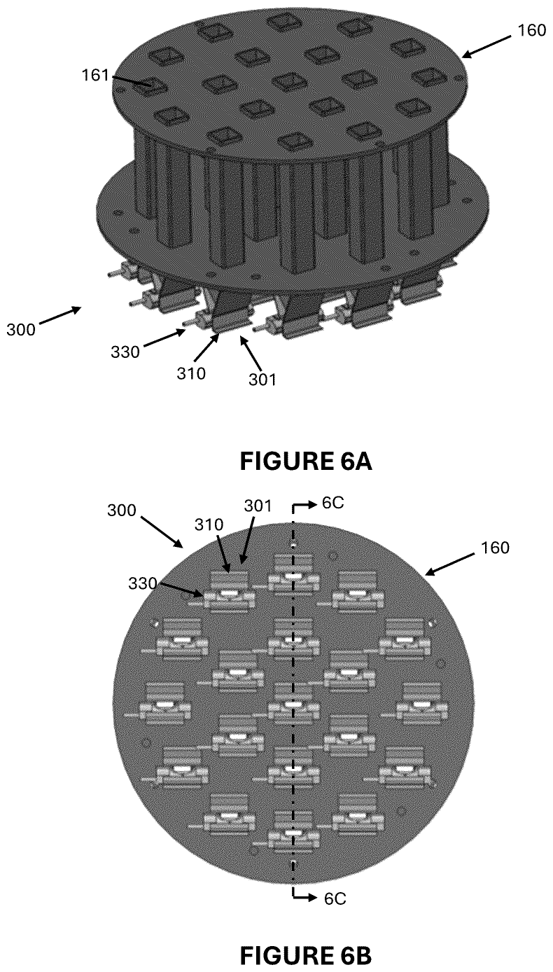

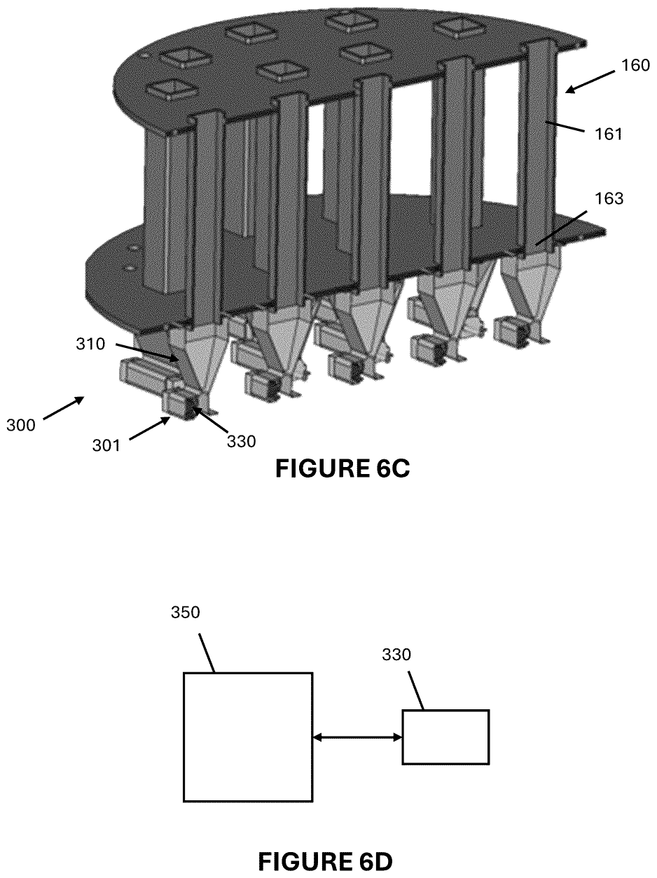

A sorbent flow regulator 300 according to one or more embodiments is shown in FIGS. 6A, 6B, and 6C. The sorbent flow regulator 300 may be positioned near or at the upstream end of the hopper 170. The sorbent flow regulator 300 includes a plurality of sorbent flow regulation modules 301 disposed on a downstream side of the sorbent receiving structure 160 at positions aligned with the sorbent passages 161. Each of the sorbent flow regulation modules 301 includes a funnel 310 and an inflatable valve 330. The inflatable valve 330 of each of the sorbent flow regulation modules 301 may be fluidly coupled to a fluid transfer device 350 as shown in FIG. 6D. The sorbent flow regulator 300 may include a single fluid transfer device 350 for all of the inflatable valves 330 or alternatively, may include a plurality of fluid transfer devices 350. The fluid transfer device 350 may be, for example, a compressed fluid (e.g., air) supply, a blower, a pump, although the fluid transfer device 350 is not limited thereto.

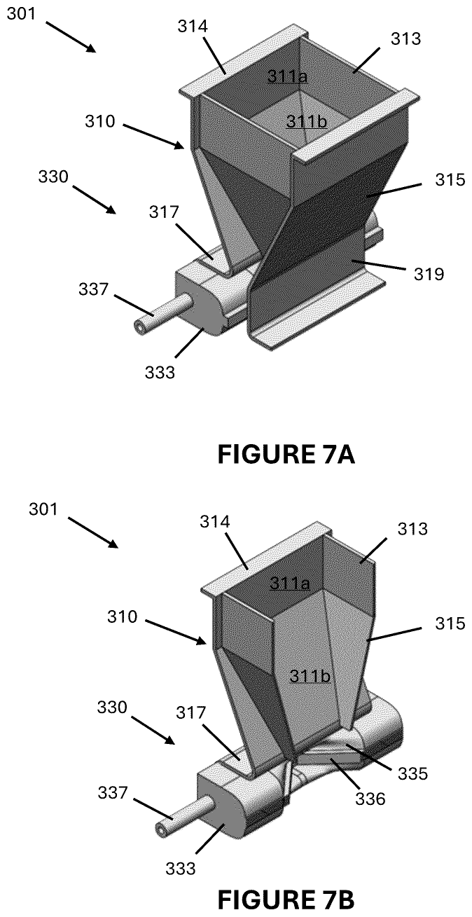

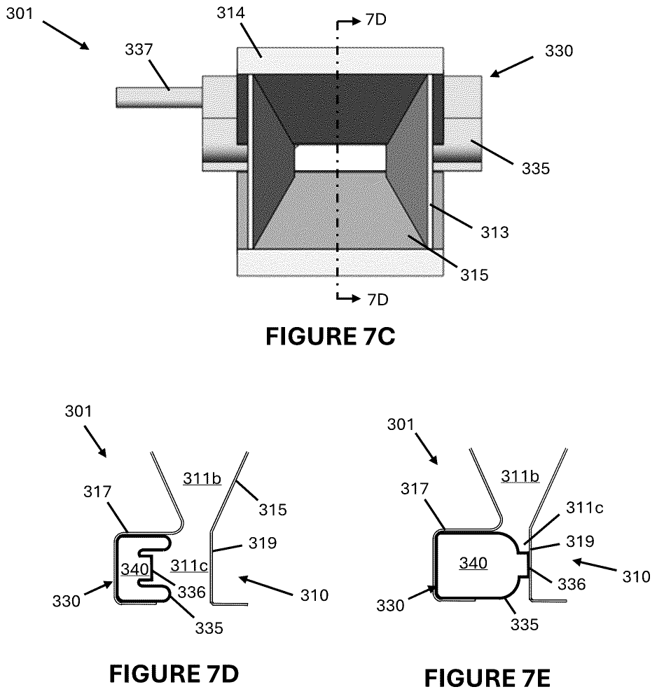

A sorbent flow regulation module 301 according to one or more embodiments are shown in FIGS. 7A-7E. The funnel 310 includes a mounting portion 314 for mounting the funnel 310 onto a downstream surface of the sorbent receiving structure 160. The mounting portion 314 may be attached to the sorbent receiving structure 160 via, for example, fasteners, welding, adhesives, and/or other attachment structures known in the art. The funnel 310 may include a first portion 313 that defines a first passage 311a therein. The first portion 313 may be structured to define the first passage 311a to have a constant cross-sectional area. The funnel 310 may include a second portion 315 downstream of the first portion 313 and defining a second passage 311b Therein. The second portion 315 may be structured to define the second passage 311b to decrease in cross-sectional area from an upstream end to a downstream end. The funnel 310 may include a valve seal gland 317 and an abutment wall 319 extending downstream from the second portion 315. The valve seal gland 317 holds the inflatable valve 330 therein. A third passage 311c is defined between the valve seal gland 317 and the abutment wall 319.

The inflatable valve 330 may be structured as a bladder defining a bladder chamber 340 therein. The inflatable valve 330 may include a fluid line 337 that fluidly couples the inflatable valve 330 to the fluid transfer device 350 (see FIG. 6D). The inflatable valve 330 may include a rigid portion 333 and an inflatable portion 335. A protrusion 336 may be formed on the inflatable portion 335 facing the abutment wall 319. The protrusion 336 may extend to the rigid portion 333.

The fluid transfer device 350 may vacate fluid from the bladder chamber 340 in the inflatable valve 330 to deflate the inflatable valve 330 such that the sorbent flow regulator 300 is in an open configuration shown in FIG. 7D. In the open configuration of the sorbent flow regulator 300, a gap is formed in the third passage 311c between the protrusion 336 of the inflatable valve 330 and the abutment wall 319, allowing the lean sorbent to pass through the third passage 311c.

The fluid transfer device 350 may flow fluid into the bladder chamber 340 in the inflatable valve 330 to inflate the inflatable valve 330 such that the sorbent flow regulator 300 is in a closed configuration shown in FIG. 7E. In the closed configuration of the sorbent flow regulator 300, the protrusion 336 of the inflatable valve 330 may abut and press against the abutment wall 319 to block the third passage 311c, preventing the lean sorbent from passing through the third passage 311c.

In the closed configuration of the sorbent flow regulator 300, a gap may be formed in the third passage 311c between the protrusion 336 of the inflatable valve 330 and the abutment wall 319, while still preventing the lean sorbent from passing through the third passage 311c. For example, the sorbent flow regulator 300 may be structured and/or controlled such that the gap is equal to or less than a bridging gap of the lean sorbent.

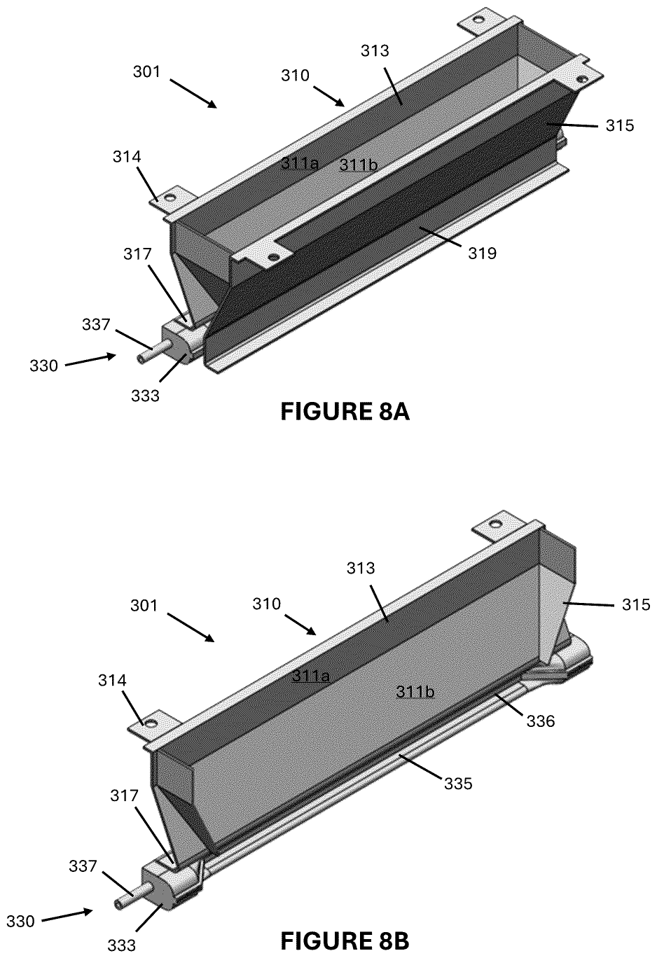

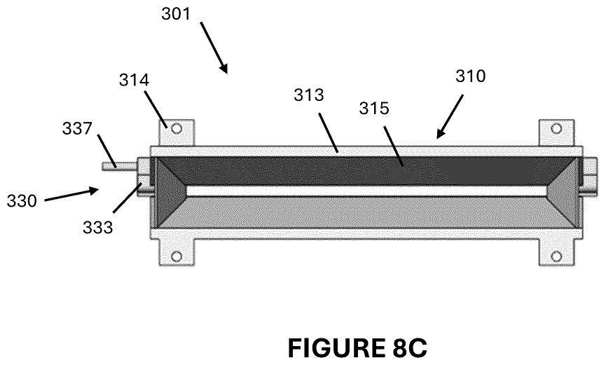

While FIGS. 6A-6C and 7A-7C show a sorbent flow regulation module 301 for each of the sorbent passages 161, the sorbent flow regulation module 301 may also be structured to receive the lean sorbent from multiple sorbent passages 161. For example, as shown in FIGS. 8A-8C, the funnel 310 and the inflatable valve 330 may be elongated and aligned with a row of sorbent passages 161 so as to receive lean sorbent from the row of sorbent passages 161.

While the above description includes descriptions of rich sorbent upstream of the desorption chamber 140 and lean sorbent downstream of the desorption chamber 140 to facilitate understanding of the desorption system 100, this is not intended to be limiting. For example, the desorption system 100 may process and/or control rich sorbent, lean sorbent, or a combination thereof upstream of the desorption chamber 140 and rich sorbent, lean sorbent, or a combination thereof downstream of the desorption chamber 140.

Set forth below are some embodiments of the foregoing disclosure:

Embodiment 1: A desorption structure including a desorption chamber structured to have desorption of sorbent performed therein, the desorption chamber defining a first portion, a second portion downstream of the desorption chamber, and a sorbent flow regulator disposed within the second portion configured to control flow of the sorbent through the desorption structure.

Embodiment 2: The desorption structure as in any prior embodiment, wherein the second portion comprises a hopper, and the sorbent flow regulator is disposed within the hopper.

Embodiment 3: The desorption structure as in any prior embodiment, wherein the sorbent flow regulator is positioned at an upstream end of the hopper.

Embodiment 4: The desorption structure as in any prior embodiment, wherein the second portion comprises a sorbent receiving structure upstream of the hopper and configured to receive the sorbent from the desorption chamber and feed the sorbent to the hopper.

Embodiment 5: The desorption structure as in any prior embodiment, wherein the sorbent receiving structure defines a plurality of sorbent passages therein, and the sorbent flow regulator is configured to control flow of the sorbent from each of the plurality of sorbent passages to the hopper.

Embodiment 6: The desorption structure as in any prior embodiment, wherein the sorbent flow regulator comprises a plurality of plugs that are configured to block outlets of the plurality of sorbent passages.

Embodiment 7: The desorption structure as in any prior embodiment, wherein the sorbent flow regulator has a closed configuration in which the plurality of plugs are moved into outlets of the plurality of sorbent passages to block flow of the sorbent therethrough, and an open configuration in which the plurality of plugs are moved away from the outlets of the plurality of sorbent passages to allow flow of the sorbent therethrough.

Embodiment 8: The desorption structure as in any prior embodiment, wherein each of the plurality of plugs has a tapered shape.

Embodiment 9: The desorption structure as in any prior embodiment, wherein the sorbent flow regulator comprises a plurality of spokes defining opening therebetween, the plurality of plugs being disposed on the plurality of spokes.

Embodiment 10: The desorption structure as in any prior embodiment, wherein the sorbent flow regulator comprises an actuator configured to move the plurality plugs between the closed configuration and the open configuration.

Embodiment 11: The desorption structure as in any prior embodiment, wherein the sorbent flow regulator comprises one or more sorbent flow regulation modules comprises an inflatable valve.

Embodiment 12: The desorption structure as in any prior embodiment, wherein the sorbent flow regulator has a closed configuration in which the one or more inflatable valves are inflated to block flow of the sorbent therethrough, and an open configuration in which the one or more inflatable valves are deflated to allow flow of the sorbent therethrough.

Embodiment 13: The desorption structure as in any prior embodiment, wherein the sorbent flow regulator comprises one or more funnels, and the inflatable valve is mounted proximate to the funnels.

Embodiment 14: The desorption structure as in any prior embodiment, wherein the sorbent flow regulator has a closed configuration in which the one or more inflatable valves are inflated towards an abutment wall of the funnel to block flow of the sorbent therethrough, and an open configuration in which the one or more inflatable valves are deflated to move away from the abutment wall allow flow of the sorbent therethrough.

Embodiment 15: The desorption structure as in any prior embodiment, wherein each of the one or more inflatable valves comprises a protrusion that abuts against or is positioned proximate to the abutment wall in the closed configuration.

Embodiment 16: The desorption structure as in any prior embodiment, wherein the second portion comprises a hopper in which the sorbent flow regulator is disposed, and a sorbent receiving structure upstream of the hopper and configured to receive the sorbent from the desorption chamber and feed the sorbent to the hopper, and the one or more funnels are mounted on a downstream surface of the sorbent receiving structure.

Embodiment 17: The desorption structure as in any prior embodiment, wherein the sorbent receiving structure defines a plurality of sorbent passages therein, and each of the one or more funnels is aligned with one the plurality of sorbent passages.

Embodiment 18: The desorption structure as in any prior embodiment, wherein the sorbent receiving structure defines a plurality of sorbent passages therein, and at least one of the one or more funnels is aligned with more than one of the plurality of sorbent passages.

Embodiment 19: The desorption structure as in any prior embodiment, wherein the plurality of sorbent passages are structured to choke and isolate radio frequency waves.

Embodiment 20: A desorption system including the desorption structure as in any prior embodiment, a heat generation device configured to generate and provide heat to the desorption chamber, and a gas flow generator configured to generate a flow of gas to be desorbed through the desorption chamber.

The use of the terms “a” and “an” and “the” and similar referents in the context of describing the invention (especially in the context of the following claims) are to be construed to cover both the singular and the plural, unless otherwise indicated herein or clearly contradicted by context. Further, it should be noted that the terms “first,” “second,” and the like herein do not denote any order, quantity, or importance, but rather are used to distinguish one element from another. The terms “about”, “substantially” and “generally” are intended to include the degree of error associated with measurement of the particular quantity based upon the equipment available at the time of filing the application. For example, “about” and/or “substantially” and/or “generally” can include a range of ±8% of a given value.

While the invention has been described with reference to an exemplary embodiment or embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the claims. Also, in the drawings and the description, there have been disclosed exemplary embodiments of the invention and, although specific terms may have been employed, they are unless otherwise stated used in a generic and descriptive sense only and not for purposes of limitation, the scope of the invention therefore not being so limited.

What is claimed is:

1. A desorption structure comprising:
a desorption chamber structured to have desorption of sorbent performed therein, the desorption chamber defining a first portion;
a second portion downstream of the desorption chamber; and
a sorbent flow regulator disposed within the second portion configured to control flow of the sorbent through the desorption structure.

2. The desorption structure of claim 1, wherein the second portion comprises a hopper, and the sorbent flow regulator is disposed within the hopper.

3. The desorption structure of claim 2, wherein the sorbent flow regulator is positioned at an upstream end of the hopper.

4. The desorption structure of claim 2, wherein the second portion comprises a sorbent receiving structure upstream of the hopper and configured to receive the sorbent from the desorption chamber and feed the sorbent to the hopper.

5. The desorption structure of claim 4, wherein the sorbent receiving structure defines a plurality of sorbent passages therein, and the sorbent flow regulator is configured to control flow of the sorbent from each of the plurality of sorbent passages to the hopper.

6. The desorption structure of claim 5, wherein the sorbent flow regulator comprises a plurality of plugs that are configured to block outlets of the plurality of sorbent passages.

7. The desorption structure of claim 6, wherein the sorbent flow regulator has a closed configuration in which the plurality of plugs are moved into outlets of the plurality of sorbent passages to block flow of the sorbent therethrough, and an open configuration in which the plurality of plugs are moved away from the outlets of the plurality of sorbent passages to allow flow of the sorbent therethrough.

8. The desorption structure of claim 7, wherein each of the plurality of plugs has a tapered shape.

9. The desorption structure of claim 7, wherein the sorbent flow regulator comprises a plurality of spokes defining opening therebetween, the plurality of plugs being disposed on the plurality of spokes.

10. The desorption structure of claim 7, wherein the sorbent flow regulator comprises an actuator configured to move the plurality plugs between the closed configuration and the open configuration.

11. The desorption structure of claim 1, wherein the sorbent flow regulator comprises one or more sorbent flow regulation modules comprises an inflatable valve.

12. The desorption structure of claim 11, wherein the sorbent flow regulator has a closed configuration in which the one or more inflatable valves are inflated to block flow of the sorbent therethrough, and an open configuration in which the one or more inflatable valves are deflated to allow flow of the sorbent therethrough.

13. The desorption structure of claim 11, wherein the sorbent flow regulator comprises one or more funnels, and the inflatable valve is mounted proximate to the funnels.

14. The desorption structure of claim 13, wherein the sorbent flow regulator has a closed configuration in which the one or more inflatable valves are inflated towards an abutment wall of the funnel to block flow of the sorbent therethrough, and an open configuration in which the one or more inflatable valves are deflated to move away from the abutment wall allow flow of the sorbent therethrough.

15. The desorption structure of claim 14, wherein each of the one or more inflatable valves comprises a protrusion that abuts against or is positioned proximate to the abutment wall in the closed configuration.

16. The desorption structure of claim 13, wherein the second portion comprises a hopper in which the sorbent flow regulator is disposed, and a sorbent receiving structure upstream of the hopper and configured to receive the sorbent from the desorption chamber and feed the sorbent to the hopper, and the one or more funnels are mounted on a downstream surface of the sorbent receiving structure.

17. The desorption structure of claim 16, wherein the sorbent receiving structure defines a plurality of sorbent passages therein, and each of the one or more funnels is aligned with one the plurality of sorbent passages.

18. The desorption structure of claim 16, wherein the sorbent receiving structure defines a plurality of sorbent passages therein, and at least one of the one or more funnels is aligned with more than one of the plurality of sorbent passages.

19. The desorption structure of claim 5, wherein the plurality of sorbent passages are structured to choke and isolate radio frequency waves.

20. A desorption system comprising:
the desorption structure of claim 1;
a heat generation device configured to generate and provide heat to the desorption chamber; and
a gas flow generator configured to generate a flow of gas to be desorbed through the desorption chamber.
